(19) United States
(12) Patent Application Publication
(10) Pub. No.: US 2016/0379492 A1
(43) Pub. Date: Dec. 29, 2016

(54) All In One Safety Display

(71) Applicant: Royal Truck & Equipment, Inc., Coopersburg, PA (US)

(72) Inventor: Robert H. Roy, Emmaus, PA (US)

(21) Appl. No.: 15/197,685

(22) Filed: Jun. 29, 2016

Related U.S. Application Data
(60) Provisional application No. 62/186,036, filed on Jun. 29, 2015.

(51) Int. Cl. G08G 1/09; B60Q 1/26; B60Q 1/54; G08G 1/054

(52) U.S. Cl. CPC G08G 1/09; G08G 1/054; B60Q 1/2615; B60Q 1/54

(57) ABSTRACT

The present invention provides a truck-mounted, all-in-one safety display and monitoring apparatus, with information displays featuring traffic speed and messages of caution or notice, one or more radar devices to detect and document traffic speed and other details of the vehicle's operation and surroundings, thereby improving traffic flow, increasing the safety of all interested parties, and decreasing operational and insurance costs.

### CROSS REFERENCE TO RELATED APPLICATIONS

The present application claims priority under 35 U.S.C, §119(e) from U.S. Provisional Application Ser. No. 62/186,036, filed Jun. 29, 2015. The entire contents of this application are incorporated by reference herein.

### FIELD OF THE INVENTION

The present invention pertains to occupational and traffic safety, specifically for the transportation and construction industries,

BACKGROUND OF THE INVENTION

Many situations exist wherein drivers must be notified of particular information, including changes to driving patterns or access, hazardous conditions and or construction zones. This information must be communicated clearly, quickly and easily, with excessive effort neither on the part of the communicating body nor on the part of the driver. These messages are critical for efficient traffic flow, maximum safety precautions in extreme weather, the safety of the driving and surrounding public, and the safety of public works and construction workers. Such messages, communicated efficiently and effectively, call for substantial equipment, installation and maintenances This equipment may be required in one central location, by which most affected parties will pass, and/or may be needed as a mobile mode of communication—either alternating among various, specific locations or travelling among the traffic. The problem of bringing all required safety, display and radar equipment to construction zones and other work sites is that it frequently necessitates the use of multiple vehicles and/or trips to the site. This leads to wasteful use of gas, time, and labor, and decreases the effectiveness of the safety efforts and message.

This multi-phase or multi-step process of transportation and installation at the desired construction zone or other site is not only cumbersome, but it also prevents continuous and/or quick conversion from the state in which the communication device is transported and the functional state it assumes upon arrival and set-up or installation. Frequently, because the radar display, message boards, and other integrated pieces arrive to work sites in different pieces or shipments, multiple vehicles will be arriving and/or remaining on-site, further aggravating the safety and practical issues with limited space in and around highway and other construction sites. Finally, increasing such activity, as well as increasing the number of vehicles and/or pieces or parts of equipment further threatens the safety of the drivers of the construction and delivery vehicles, the drives of the general population, and the individuals on-site.

The risks of collisions among drivers, and more serious risks to which on-site workers are exposed, is the impetus for the development of the present invention. The ideal role for the present invention is “end of queue” deployment—that is at the beginning of a work zone. The risk for motor vehicle accidents and other collisions greatly increases in cases where there are temporary lane closures. Truck mounted attenuator (TMA) construction trucks are commonly used in these circumstances.

Traffic and transportation studies demonstrate that rear-end collisions are the most common type of collision in work zones and occur most often in this context.¹ Factors affecting ¹Ullman G. L., Iragavarapu, V., and Brydia, R. E. Safety Effects of Portable End-of-Queue Warning System Deployments at Texas Work Zones. Submitted for presentation at Transportation Research Board Annual Meeting and Publication. Jan. 10-14, 2016, Washington D.C. these collisions include traffic density and demands, work zone activity, the time-of-day, and reductions in capacity of the particular throughway. That said, temporary lane closures, defined as those nut in place for a single work day or shill, were the most dangerous, leading to a jump in collision risk, as high as sixty-six percent (66%), depending on the time of day.² A commonly theorized cause of these collisions, especially the larger, more violent collisions, is the higher speed traffic approaching the work zone/queue and the slower-moving traffic in the queue (in the vicinity of the work zone). As so many counter-measures are employed to combat this very real, dangerous, and financially impactful problem, without real metrics as to which are most effective, studies of individual methods have been inconsistently conducted and sample sizes have been relatively small.²Id. at p. 3.

The Texas Depart of Transportation instituted a particular method for around six (6) years while a major interstate highway underwent extensive widening. It developed a standard for a portable end-of-queue warning system made up of a radar-based speed detector and message sign, coupled with rumble strips and installed these on the highway ahead of the work zone and lane closures. Although a relatively small study, there was a clear demonstration of efficacy, decreasing collisions by forty-four percent (44%), compared to work sites without a traffic speed or message display.³ Those collisions which were not avoided were less severe, presumably due to the overall decrease in vehicle speeds in response to the warning system. The study reviewers estimate a lowering of costs due to motor vehicle collisions during the study period of about $1.36 million.⁴³Id. at p. 11.⁴Id. at p. 12.

As noted herein, current technology and practice allow no way to accomplish the task of transporting and installing safety messaging boards and traffic speed displays to various sites at which they are needed, without the hindrances, inconveniences and inefficiencies noted above.

### SUMMARY OF THE INVENTION

The present invention provides a method of transporting and installing safety messaging boards and traffic speed displays to particular locations and/or along specific routes of travel, as desired, by providing an adaptable, transportable, all-in-one apparatus therefor. This apparatus provides an electronic display within a protective frame enclosure which can display for the benefit of passing motorists, traffic speed, messages of caution or notice, and other important information; and means to store and program, automate, or otherwise control the information to be displayed. Coupled with adjustable support posts, the apparatus can be mounted directly to the back of traffic control vehicles, thereby providing a comprehensive, effective and efficient method to provide information to, or otherwise alert, motorists, this invention improves traffic flow, increases the safety of all interested parties, and decreases operational and insurance costs.

### BRIEF DESCRIPTION OF THE FIGURES

Unless otherwise stated, all dimensions are in inches and drawings are not to scale.

FIG. 1 is a Computer Aided Design (CAD) representation of the present invention, demonstrating the potential layout of the Front Panel 1 for the Radar Display 2 and Slow Down Message Board 3.

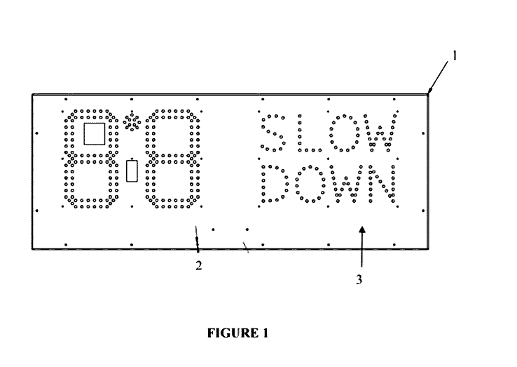

FIG. 2 is a CAD depiction of the present invention, in its more complete assembly, which comprises the Radar Display 2, Slow Down Message Board 3, the support posts 4 and support post housing 5.

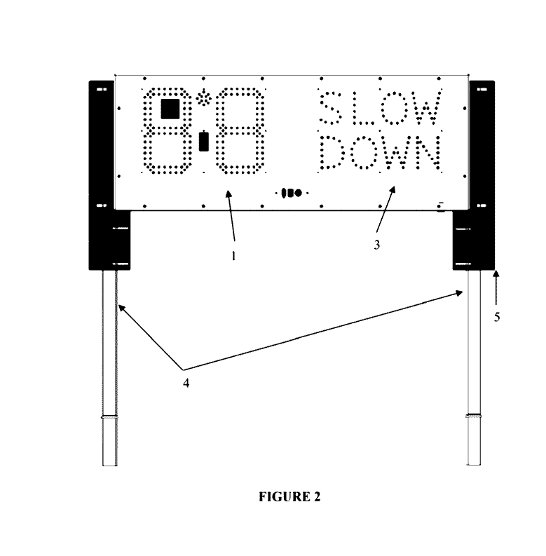

### DETAILED DESCRIPTION OF THE INVENTION

The present invention provides a comprehensive compact truck-mounted system and portable electronic display device to display and monitor traffic and safety information which incorporates a radar display, slow down display, and mini message center, which will reduce or eradicate the need for larger, more expensive tow-behind trailer-type devices.

In its preferred embodiment, the present invention provides an electronic display surface made up of one or more panels capable of displaying one or more graphical and/or textual messages, including real-time traffic speed, alerts regarding speed limits, and/or messages regarding work zones and other road hazards; situated within a frame enclosure; a radar instrument or other means of detecting and monitoring the speed of traffic; a form of memory or data storage to store various messages to display; and switches or other means of control to allow the operator or driver to input information and select messages to be displayed. The display surface and frame enclosure are affixed to sturdy, adjustable support posts; with the whole assembly mounted or otherwise installed in a vertical orientation on or to the rear of a construction or traffic-control vehicle, giving the operator the ability to display traffic information and specific warning messages to motorists in the vicinity of the work zone or other potentially hazardous site. The frame enclosure, support posts and display panels can be manufactured and assembled to meet the specifications of the particular vehicle on which it will be installed and/or the particular needs of the work site or crew, including dimensions of width and height, weight limits or weight-bearing capacity, height and other adjustability requirements, and mechanisms for protecting the apparatus and its components from weather, other external elements, jostling due to transport, and force resulting from a collision or other impact.

The present invention is comprised of among other required and optional elements, as traffic speed display or Radar Display (“RD”), Slow Down Message Board (“SDMB”), and Mini Messenger Center or System (“MMC”). The MMC, as compact, adaptable messaging sign, is easy to update and is extremely effective at capturing drivers' attention. The RD is generally comprised of a highly energy-efficient Doppler radar measurement and display alert system designed to alert each driver as to how many miles per hour s/he may be travelling in excess of the work zone's posted speed limit. Coupled with the SDMB, a digital display reminding drivers to slow down, the RD and MMC have been shown by Applicant to reduce speed in work. zones and, there can reduce injuries and even save lives. In a preferred embodiment, the RD and SDMB are positioned adjacent to each other with as small space between them and the MMC is located directly beneath the RD and SDMB. The RD and SDMB are wired together such that the SDMB activates and flashes when traffic exceeds a preset speed. The RD also flashes when traffic exceeds said preset speed. The MMC is controlled via a separate remote and can be set to display one or more preloaded messages. Various combinations of displays and sizes, as well as specific dimensions and configurations of the RD, SDMB, and MMC are possible, depending on the nature of the primary intended uses and configuration of the particular traffic control vehicle to which the invention is affixed. The versatile design of the present invention allows users to configure and modify the various components, to suit the particular project and/or job site, The frame enclosure and support posts function to protect the internal components and make installation or reconfiguration of the package straightforward and convenient.

In one embodiment, the present invention may be operated by one or more drivers or autonomous. In another embodiment, one or more components or monitoring elements of the present invention can be linked to other operations or sites on the roadway or within the work zone. This will allow for the information being collected by the present invention to be communicated to external actors or equipment, including police and other authorities or additional safety, messaging and notice equipment.

In one embodiment of the present invention, the vehicle will be equipped with a proximity sensor in one or more locations on the vehicle, including the rear of the vehicle, communicating to the mechanism deploying the attenuator and other equipment, whether some obstruction—person, equipment, or vehicle—was in too close proximity for such equipment to be deployed.

In another embodiment of the present invention, the RD and MMC will be mounted in a manner which allows for the largest possible physical display of each, facilitating communication to approaching motorists at further distances and impacting their behavior in advance of their entry to the work zone. This further increases the safety of those working in the work zone, and decreasing the likelihood of motorist accidents. Applicant is currently engaging in studies of usages of the present invention and the impacts on accident and injury rates two on-going studies with the departments of transportation of two different states and a university.

In a preferred embodiment of the present invention, some or all of the components will be rear-mounted. A preferred embodiment of the present invention will further include a video recording function with traffic speed information overlaid onto camera views and/or DVR recordings. This preferred embodiment includes a specifically designed and mounted digital video recorder (DVR) camera system, proprietary to the Applicant, which provides additional liability coverage for the end-user by documenting work zone activities and the speeds of passing traffic, using configurations of up to and including eight (8) cameras. All footage would be shown in real-time on the in-cab monitor, allowing the driver or other user to view up to four (4) camera views simultaneously, and safely assess the entire work zone. This camera view and recording, function relies upon the aspects of the present invention, as described below, and can record, specifically, upon the occurrence of one or more triggering events, including, but not limited to, a collision in the area of the work zone, deployment of the vehicle's truck-mounted attenuator, engine ignition, or vehicle movement.

The goals accomplished by this invention are increased safety, efficiency, cost-savings, fewer incidents of accidental collisions, decreased insurance premiums, employer and governmental liability and environmental impact. It provides an efficient method by which traffic speeds can be reduced in work zones and construction sites and traffic patterns can be controlled and monitored. Further, the present invention, en route to the site and upon arrival, gives motorists and other users of the particular road, route or portion thereof, advanced notice of potential hazards or dangerous conditions.

The present invention's largest role will be in the highway construction industry, it n ay have applications for other situations in which densely populated or frequently traveled locations have large numbers of people and/or vehicles, in flux, who have need for certain information to be communicated promptly and efficiently, the nature of and the required location for which, are subject to change.

### Examples

The present invention is more fully described by way of the following nom limiting examples and objects of the invention. These examples should, in no way, be construed as limiting the scope of the invention.

One example of the utility of the present invention is its usefulness in driver training and safety exercises. Reviewing traffic events, accidents or other occurrences on the road can be a helpful exercise with drivers for governmental and private entities, used by employers and/or their insurance carriers to increase awareness and safety and mitigate liability and its attendance costs. An initially unanticipated benefit of the present invention is the decrease in insurance premiums for businesses/employers operating in construction and government, agencies perforating similar functions, A. preferred. customer of Applicant has been utilizing the present invention since its earliest commercial iteration and, in this short time has experienced a fourteen percent (14%) decrease in its workers' compensation insurance policy premiums.

A major example of the present invention's usefulness is its application in work zone safety, where speed is a major factor. Drivers passing through work zones are susceptible to distractions in the form of other drivers, devices, and/or road conditions, causing them to fail to pay adequate attention to posted speed limits and road conditions and hazards, As a result, trailer-mounted radar speed displays are used to attract drivers' attention and inform them of their speed, whether it is in excess or in accordance with posted speed limits. This typically requires contractors to purchase or lease stationary radar speed display trailers in advance and position them throughout work zones. The disadvantages of such systems are numerous; they are static devices that do not move with mobile work zones and they are not capable of fully, quickly and safely grabbing the attention of passing drivers and conveying all necessary information to them. As an example of the practical implementation of the present invention, the combination of a Radar Display, Slow Down Message Board and an appropriate shadow vehicle, equipped with flashing strobes and beacons, arrow board, and truck-mounted attenuator, is much more noticeable to drivers due to the varied appearance of this combination, as well as the novelty of its use in traffic safety. Passing drivers are more likely to notice a large, medium-duty shadow vehicle with flashing lights, flashing Radar Display, and flashing Slow Down Message Board more easily than a standard radar display trailer because it attracts the drivers attention and peripheral view, while driving. One possible means of illumination fir the various display panels is the use of light emitting diode (LED) lights on each panel.

Furthermore, a growing number of states require Full-Matrix Message Boards to inform passing drivers of changing road and traffic conditions throughout the work zone. Again, the current solution available to contractors and construction crews is to place expensive, stationary trailer-mounted message boards in advance and throughout the work zone. As with trailer-mounted radar speed displays, trailer-mounted full-matrix message boards are static devices which cannot move with a mobile work zone efficiently and may go unnoticed due to its unchanging appearance and the driver's frequent exposure to the same devices. The addition of a Mini Message Center, as in the present invention, to the aforementioned combination allows contractors to maintain drivers' attention while also disseminating significant amounts of information in a digestible manner, including: driver speed, whether the driver is in excess of posted speed limits, and what conditions the driver can expect in the upcoming work zone.

The above examples of the present invention demonstrate its ability to quickly and safely capture the attention of passing drivers to heighten awareness and improve safety throughout the work zone. Another combination of equipment merges the examples described above with the addition of a DVR recording system. The three functional elements can be integrated together to provide statistical traffic speed information and video monitoring for the contractor. This information can be utilized by the contractor in a variety of ways in order to more efficiently and safely perform and complete its work. This may entail applying for increased law enforcement efforts and/or providing the support for arguments to reduce speed limits in and around the work zone. It can also be used by the contractor to train, inform, and improve safety practices within its work zones, justifying itself practically to the user/contracting company by saving labor, insurance premiums and payouts and, more importantly, saving lives. Currently, there are no commercially available systems or devices that integrate a Radar Display, Slow Down Message Board, Mini Message Center, DVR Recording System, and statistical analysis software, as used herewith by Applicant, for improving work zone safety or tracking useful data metrics within a work zone.

The final example of the present invention contemplated by Applicant provides the basis of an integrated, complete, remotely controlled information and traffic control device. A shadow vehicle, equipped with any combination of Radar Display, Slow Down Message Board, DVR Recording System, and Statistical Traffic Speed Analysis Software can be up-fitted with autonomous drone technology to provide the user/contractor with an integrated traffic control and monitoring system that keeps workers out of traffic. An autonomous shadow vehicle, equipped with such systems and devices, could be remotely deployed, positioned, and monitored within a stationary or mobile work zone to provide protection fir workers. As fully described herein, this iteration of the present invention would inform passing motorists of work zone activities and traffic speeds, and track traffic data, but in this example no worker would be required on site, on the road, interacting with traffic, for its operation. In a further description of this example, the traffic. and other information can be downloaded over a cellular network for use by the contractor.

### Prototype and Results of Experimental and Commercial Usage

The current invention has been developed and utilized since July of 2014, first in an experimental capacity, then as a commercial product, as part of the myriad proprietary products produced and sold by Applicant. There have been several renderings of the present invention and adaptations made by Applicant during its experimental phase, as the concept evolved to the embodiments and examples contemplated herein. Since the start of commercial sales of the present invention by Applicant, over forty iterations of the embodiment of the present invention consisting of the RB, SDMB, and DVR/camera system have been sold, with three-quarters of these products also containing the MMC. Applicant expects to sell at least ten (10) more products embodying the invention before the end of calendar year 2016.

The foregoing examples and description of the preferred embodiments should be interpreted as illustrating, rather than as limiting, the present invention as herein defined. All variations and combinations of the features above are intended to be within the scope of this application.

We claim:

1. A vehicle-mounted electronic display apparatus capable of displaying and monitoring traffic and safety information comprising:
(a) a substantially vertical frame enclosure and one or more support posts, wherein the frame enclosure is secured to the support post(s) by means capable of attaching heavy metal objects;
(b) an electronic display surface including at least one display panel that displays a graphical and/or textual message;
(c) a means of measuring traffic speed;
(d) memory that stores a plurality of messages;
(e) one or more switches on the apparatus that allows the operator to select one of the messages or a series thereof

2. The apparatus of claim 1, wherein the display panels comprise one or more of the following:
(a) Radar Display;
(b) Slow Down Message Board;
(c) Mini Message Center.

3. The apparatus of claim 1, wherein some or all of the display panels are mounted to the rear of the vehicle,

4. The apparatus of claim 1, wherein the vehicle is equipped with one or more proximity sensors in one or more externally facing positions on the vehicle, including the rear of the vehicle, capable of signaling the presence of an obstruction in the vicinity of the vehicle during deployment and use of the apparatus.

5. The apparatus of claim 1 wherein the display panels arc populated with LED lights,

6. The apparatus of claim 1, wherein the frame enclosure, support posts. and display panels are manufactured and assembled to meet the specifications of the particular vehicle on which it will be installed, including dimensions of width and height, weight-bearing capacity, adjustability requirements, and mechanisms for protecting the apparatus and its components from weather, other external elements, jostling due to transport, and force resulting from a collision or other impact.

7. The apparatus of claim 1, further comprising a DVR and camera system secured on or within the vehicle, capable of documenting work zone activities and the speeds of passing traffic, comprising:
(a) one (1) or more video cameras;
(b) monitor in the cab of the vehicle, allowing the operator to observe one or more camera views simultaneously and in real-time;
(c) memory that stores recorded footage and related information regarding work zone and traffic.

8. The apparatus of claim 2 wherein the Radar Display and Slow Down Message Board are positioned adjacent to each other within the vertical frame enclosure with a small space of open display separating them and the Mini Message Center is located directly beneath the Radar Display and Slow Down Message Board.

9. A vehicle-mounted electronic, display apparatus, generally installed on and affixed to the rear of the vehicle, which is capable of displaying and monitoring traffic and safety information comprising:
(a) a substantially vertical frame enclosure and two or more support posts, wherein the frame enclosure is secured on each side by parallel left and right support posts through a series of bolts, welding or other means of attachment, and wherein the support posts are secured at the base to a flatbed or shelf, plate or other structure on the vehicle through a series of bolts, welding or other means of attachment, and wherein the frame enclosure comprises an accessible interior section capable of maintaining one or more display panels, and one or more horizontal crossbars or diagonally disposed stabilization bars;
(b) an electronic display surface including at least one display panel that displays a graphical and/or textual message, wherein each display panel has a front or outward-facing panel and a back, or inward-facing panel, from the perspective of the vehicle, and wherein each display panel contains a grid of illuminable elements;
(c) a means of measuring traffic speed, wherein such means are comprised of a Doppler or other radar instrument;
(d) memory that stores a plurality of messages;
(e) one or more controls switches on the apparatus that allows the operator to select one of the messages or a series thereof.

10. The apparatus of claim 9, further comprising wireless communication capability for completely customizable messages.

11. The apparatus of claim 9, wherein the frame enclosure, support posts and display panels are manufactured and assembled to meet the specifications of the particular vehicle on which it will be installed, including, dimensions of width and height, weight-bearing capacity, adjustability requirements, and mechanisms for protecting the apparatus and its components from weather, other external elements, jostling due to transport, and force resulting from a collision or other impact.

12. The apparatus of claim 9, further comprising a DVR and camera system secured on or within the vehicle, capable of documenting work zone activities and the speeds of passing traffic, comprising
(a) one or more video cameras;
(b) radar detector or other means of determining traffic speed information;
(c) monitor in the cab of the vehicle, allowing the operator to observe one or more camera views simultaneously and in real-time, wherein traffic speed information is also represented;
(d) memory that stores recorded footage, traffic speed information, and related information regarding work zone and traffic.

13. A method of information display and monitoring whereby a message and display system operates to provide roadside and worksite safety comprising:
(a) wiring together the Radar Display and Slow Down Message Board;
(b) causing the Slow Down Message Board to activate and flash when passing traffic exceeds a preset speed;
(c) causing the Radar Display to display the speed of passing traffic and flash when traffic exceeds said preset speed; and
(d) allowing the operator to control the Mini Message Center via to separate remote and can be set to display one or more preloaded messages.
